(19) United States
(12) Patent Application Publication
(10) Pub. No.: US 2013/0215230 A1
(43) Pub. Date: Aug. 22, 2013

(54) Augmented Reality System Using a Portable Device

(71) Applicants: Matt Miesnieks, San Francisco, CA (US); Silka Miesnieks, San Francisco, CA (US); Yohan Baillot, San Francisco, CA (US); Marc Gardeya, San Francisco, CA (US); Leonid Naimark, Boston, MA (US); Anthony Maes, San Francisco, CA (US); John Sietsma, Melbourne (AU)

(72) Inventors: Matt Miesnieks, San Francisco, CA (US); Silka Miesnieks, San Francisco, CA (US); Yohan Baillot, San Francisco, CA (US); Marc Gardeya, San Francisco, CA (US); Leonid Naimark, Boston, MA (US); Anthony Maes, San Francisco, CA (US); John Sietsma, Melbourne (AU)

(21) Appl. No.: 13/774,762

(22) Filed: Feb. 22, 2013

Related U.S. Application Data
(60) Provisional application No. 61/601,775, filed on Feb. 22, 2012.

(51) Int. Cl. H04N 13/02

(52) U.S. Cl. CPC H04N 13/02
USPC 348/46

(57) ABSTRACT

A system and a method are disclosed for capturing real world objects and reconstructing a three-dimensional representation of real world objects. The position of the viewing system relative to the three-dimensional representation is calculated using information from a camera and an inertial motion unit. The position of the viewing system and the three-dimensional representation allow the viewing system to move relative to the real objects and enables virtual content to be shown with collision and occlusion with real world objects.

### CROSS-REFERENCE TO RELATED APPLICATIONS

This application claims the benefit of U.S. Provisional Application No. 61/601,775, filed Feb. 22, 2012, which is hereby incorporated by reference in its entirety.

### BACKGROUND

1. Field of Art

The disclosure generally relates to the field of augmented reality, and more specifically to real-time augmented reality systems.

2. Description of the Related Art

Augmented Reality (AR) systems allow the production of virtual content along with real world objects. These AR systems overlay computer interfaces or objects on top of images or video of the real world. For example, a video of a sporting match can be highlighted with the position of a ball, or a football game can have a first down line drawn on a field automatically. Other AR systems can allow depiction of virtual objects in a nearby area. For example, AR systems may overlay information on top of a view of the world, such as reviews of local restaurants overlaid on an image of the restaurant.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows a system for displaying augmented reality (AR) content according to one embodiment.

FIGS. 2A-2C illustrate the screen of a mobile device in one embodiment.

FIG. 3 illustrates the components of an AR system are according to one embodiment.

FIG. 4 illustrates one embodiment of a view of the components of the system.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of an augmented reality system enables interaction of virtual content with real world objects. The augmented reality system obtains a scene using a camera to capture real world objects. The real world objects are converted into a three-dimensional model by detecting features in the scene viewed by the camera. Using the video feed from the camera, features are detected in the object, which are also used to determine the position of the augmented reality system in space. In this embodiment, the position can also be determined using inertial sensors and a dead reckoning system. The final position of the system is calculated by combining the video- and inertial-based position systems, which further reduces the errors of each separate calculation. Virtual content is rendered in the modeled scene and provided as an overlay to the video feed to the user to provide an augmented reality system incorporating collision and occlusion with real world objects.

### Augmented Reality Occlusion

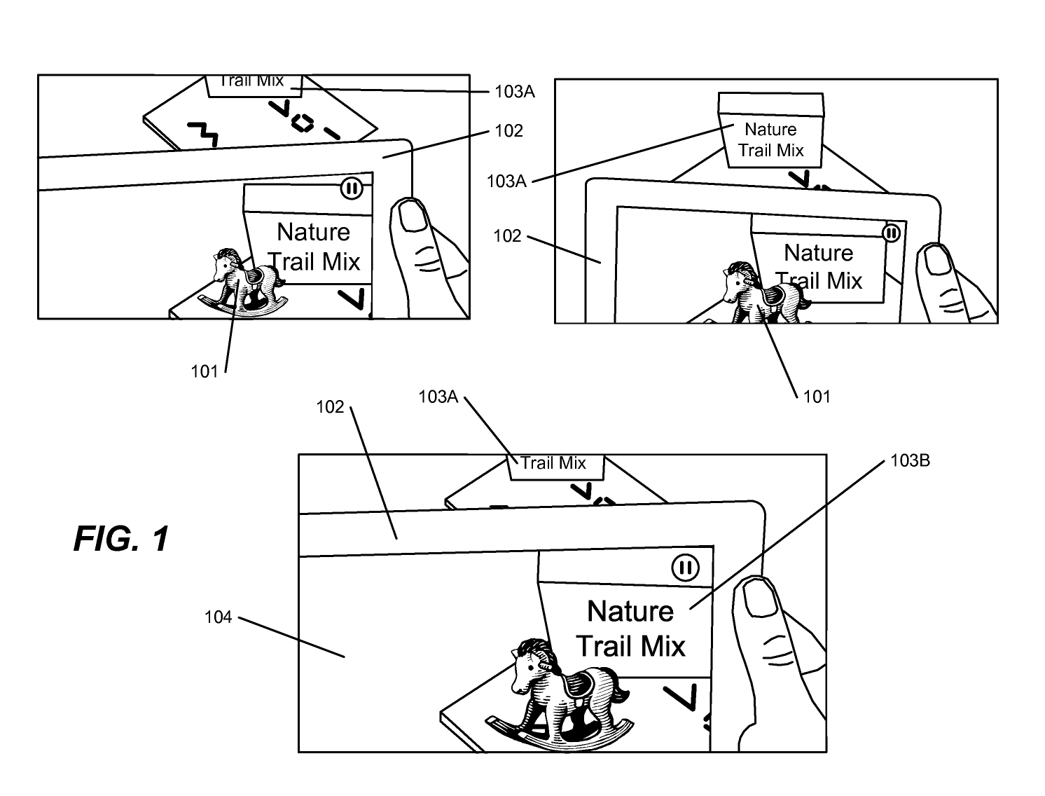

FIG. 1 shows an overview of a system for displaying augmented reality (AR) content according to one embodiment. The user uses a mobile device 102, which in one embodiment includes a camera, inertial sensors and a screen. The mobile device 102 depicts real world objects 103A which can be viewed as real world objects 103B on a live video 104 on the screen. The real world objects 103A are translated into an internal three-dimensional representation. The mobile device uses the video captured by the camera as well as inertial sensors to determine the position (“pose”) of the mobile device 102 with respect to the real world objects 103A and within the internal three-dimensional representation. Using the pose of the mobile device 102, virtual content 101 is superimposed on the real world objects 103B on the screen of the mobile device 102. In one embodiment, the pose of the mobile device 102 is calculated using the video captured by the camera as well as the inertial sensors. Using the pose of the mobile device 102, the system overlays the virtual content 101 so that the virtual content 101 appears to be fixed with respect to the real world displayed on the screen. As the mobile device 102 is moved in space relative to real world objects 103A, the location of the virtual content 101 is identified and maintained relative to the real world objects 103B displayed on the screen.

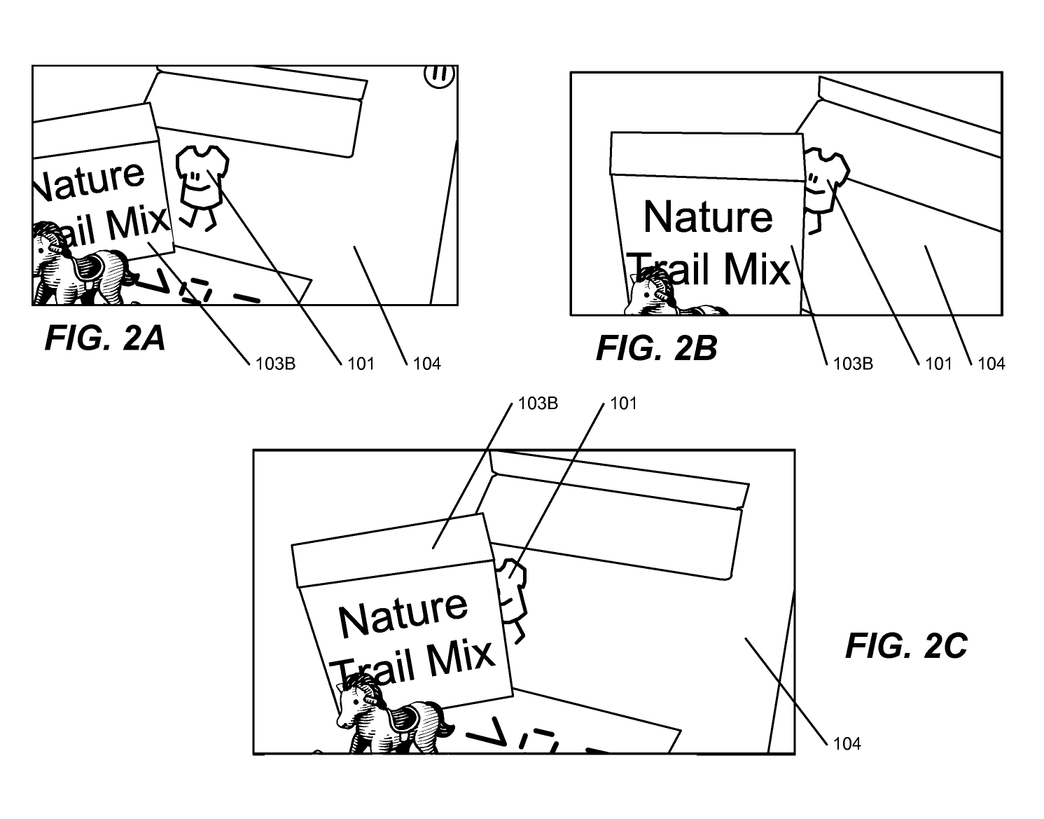

FIGS. 2A-2C illustrate the live video 104 displayed on the screen of the mobile device 102 in one embodiment. In addition to displaying virtual content, FIGS. 2A-2C illustrate the ability of the system to occlude the virtual content 101 with the real world objects 103B according to an embodiment. This mutual occlusion on the device 102 is shown as a combination of video 104 and the partially occluded virtual content 101. Shown in FIG. 2A, the virtual content 101 stands beside the real world object 103B. In FIGS. 2B and 2C, the virtual content 101 is partially occluded by the real world object 103B. The occlusion occurs because the three-dimensional representation of the real-world object 103B allows the system to render the virtual content 101 with respect to the three-dimensional representation of the real-world object. Since the virtual content 101 is located in the three-dimensional representation at a further distance to an opaque object (specifically, real-world object 103B), the rendered portion of the virtual content 101 is occluded by the real world object 103B. In addition to occlusion, the use of a three-dimensional representation enables the virtual content 101 to collide with and interact with the real world object 103B shown on the live video 104. Since the virtual content 101 is located “behind” the real world object 103B, and the system understands the pose of the mobile device 102 in relation to the real world object 103A, the user can move the device to the other side of the real world object 103A, and the virtual content 101 would appear unoccluded from real world object 103B.

### Augmented Reality System Components

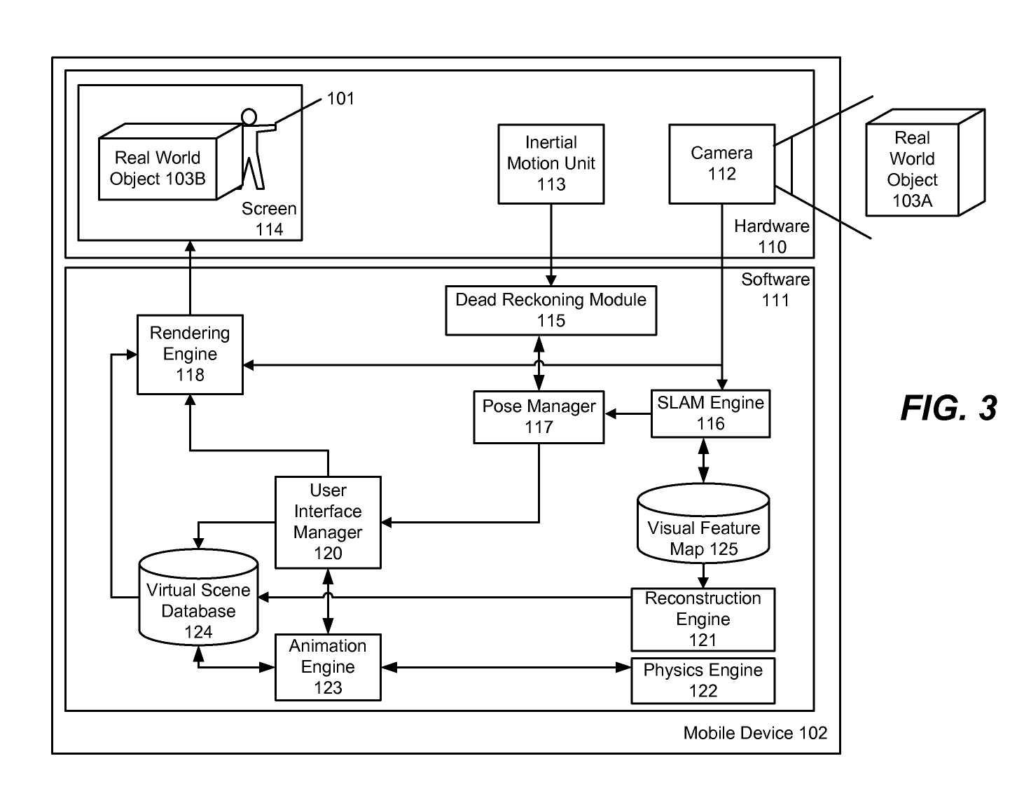

Referring now to FIG. 3, the components of an AR system are shown according to one embodiment. As shown in this embodiment, the mobile device includes several hardware components 110 and software components 111. In varying embodiments and as understood by a skilled artisan, the software components 111 may be implemented in specialized hardware rather than implemented in general software or on one or more processors.

The hardware components 110 in one embodiment can be those such as the mobile device 102. For example, the hardware components 110 can include a camera 112, an inertial motion unit 113, and a screen 114. The camera 112 captures a video feed of real world objects 103A. The video feed is provided to other components of the system to enable the system to determine the pose of the system relative to objects 103B, construct a three-dimensional representation of the objects 103B, and provide the augmented reality view to the user.

The inertial motion unit (IMU) 113 is a sensing system composed of several inertial sensors which includes an accelerometer, gyroscope, and magnetometers. In other embodiments, additional sensing systems are used which also provide information about movement of the mobile device 102 in space. The IMU 113 provides inertial motion parameters to the software 111. The IMU 113 is rigidly attached to the mobile device 102 and thereby provides a reliable indication of the movement of the entire system and can be used to determine the pose of the system relative to the real world objects 103A viewed by the camera 112. The inertial parameters provided by the IMU 113 include linear acceleration, angular velocity and gyroscopic orientation with respect to the ground.

The screen 114 displays a live video feed 104 to the user and can also provide an interface for the user to interact with the mobile device 102. The screen 114 displays the real world object 103B and rendered virtual content 101. As shown here, the rendered virtual content 101 may be at least partially occluded by the real world object 103B on the screen 114.

The software components 111 provide various modules and functionalities for enabling the system to place virtual content with real content on the screen 114. The general functions provided by the software components 111 in this embodiment are to identify a three-dimensional representation of the real world objects 103A, to determine the pose of the mobile device 102 relative to the real world objects 103A, to render the virtual content using the pose of the mobile device with respect to the real world objects, and to enable user interaction with the virtual content and other system features. The components used in one embodiment to provide this functionality are further described below.

The software 111 includes a dead reckoning module (DRM) 115 to compute the pose of the mobile device 102 using inertial data. That is, the DRM uses the data from the IMU 113 to compute the inertial pose, which is the position and orientation of the mobile device 102 with respect to the real world objects 103. This is done using dead-reckoning algorithms to iteratively compute the pose relative to the last computed pose using the measurements from the IMU 113. In one embodiment, the DRM calculates the relative change in pose of the mobile device 102 and further provides a scale for the change in pose, such as inches or millimeters.

A Simultaneous Localization and Mapping (SLAM) engine receives the video feed from the camera 112 and creates a three-dimensional (3D) spatial model of visual features in the video frames. Visual features are generally specific locations of the scene that can be easily recognized from the reset of the scene and followed in subsequent video frames. For example, the SLAM engine 116 can identify edges, flat surfaces, corners, and other features of real objects. The actual features used can change according to the implementation, and may vary for each scene depending on which type of features provide the best object recognition. The features chosen can also be determined by the ability of the system to follow the particular feature frame-by-frame. By following those features in several video frames and thereby observing those features from several perspectives, the SLAM engine 116 is able to determine the 3D location of each feature through stereoscopy and in turn create a visual feature map 125.

In addition, the SLAM engine 116 further correlates the view of the real world captured by the camera 112 with the visual feature map 125 to determine the pose of the camera 112 with respect to the scene 103. This pose is also the pose of the hardware assembly 110 or the device 102 since in this example embodiment the camera is rigidly attached and part of those integrated components.

The pose manager 117 manages the internal representation of the pose of the mobile device 102 relative to the real world. The pose manager 117 obtains the pose information provided by the dead reckoning module 115 and the SLAM engine 116 and fuses the information into a single pose. Generally, the pose provided by the IMU is most reliable when the mobile device 102 is in motion, while the pose provided by the SLAM engine 116 (which was captured by the camera 112) is most reliable while the mobile device 102 is stationary. By fusing the information from the both poses, the pose manager 117 generates a pose which is more robust than either alone and can reduce the statistical error associated with each.

The pose estimation function determines the pose of the hardware assembly 110 or system 102. The pose manager 117 computes this pose by fusing the inertial-based pose computed by the dead-reckoning module 115 and the vision based pose computed by the SLAM engine 116 using a fusion algorithm and makes the fused pose available for other software components. The fusion algorithm can be, for example, a Kalman filter. The SLAM engine 116 produces the vision-based pose using a SLAM algorithm, using camera video frames from different perspectives of the scene 103 to create a visual map 125. It then correlates the live video from the camera 112 with this visual feature map 125 to determine the pose of the camera with respect to the scene 103. The DRM 115 produces the inertial-based pose using the raw inertial data coming from the IMU 113.

In many mobile devices 102, there are particular limitations which can be addressed by the pose manager 117. For example, the inertial data provided by the IMU may be sampled infrequently at 100 Hz (i.e., infrequent relative to high-end sensors) and additionally have a relatively high error rate. In addition, the processing required to determine the pose from video frames can be high relative to the processing power available on the mobile device 102. As a result, determining a pose from the video frames at 30 frames per second may be overly computationally intensive. By fusing the video frame pose data with the IMU pose data at the pose manager 117, the system is able to compensate for both of these defects. The video frame data augments the inertial pose data to reduce the sampling error, and the inertial pose data allows a reduced frequency of sampling the video frames. For example, in one embodiment the fusion of inertial and vision pose data allows a reduction in processing for vision pose data to 5-6 frames per second rather than the full captured video stream of 30 frames per second. The combination of these two pose sources compensates for the deficiencies of each. In one embodiment, the fusion of the poses is accomplished using a Kalman filter.

The visual feature map 125 is a data structure which encodes the 3D location and other parameters describing the visual features generated by the SLAM engine 116 as the scene 103A is observed. For example, the visual feature map 125 may store points, lines, curves, and other features identified by the SLAM engine from the real world objects 103A.

The reconstruction engine 121 uses the visual feature map 125 generated by the SLAM engine 116 to create a surfaced model of the scene 103 by interpolating surfaces from the visual features. That is, the reconstruction engine 121 accesses the raw feature data from the visual feature map 125 (e.g., a set of lines and points from a plurality of frames) and constructs a three-dimensional representation to create surfaces from the visual features (e.g., planes).

The scene modeling function performed by the reconstruction engine 121 creates a 3D geometric model of the scene. It takes as input the feature map 125 generated by the SLAM engine 116 and creates a geometric surface model of the scene to generate a surface from points that are determined to be part of this surface. For example in creating an implicit surface using the visual feature points as key points, or by creating a mesh out of triangles created between points that are close to each other. By controlling how many visual features are collected by the SLAM engine 116 at each frame, and in turn controlling the density of the visual map 125, it is possible to create a surfaced virtual model that is close to the actual geometry of the real world being observed. The reconstruction engine 121 stores the 3D model in the virtual scene database 124.

The animation engine 123 is responsible for creating, changing, and animating virtual content. The animation engine 123 responds to animation state changes requested by the user interface manager 120 such as moving a virtual character from one point to another. The animation engine 123 in turn updates the position, orientation or geometry of the virtual content to be animated in each frame in the virtual database 124. The virtual content stored in the virtual scene database 124 is later rendered by the rendering engine 118 for presentation to the user.

The physics engine 122 interacts with the animation engine 123 to determine physics interactions of the virtual content with the three-dimensional model of the world. The physics engine 122 manages collisions between the geometry and content that it is provided with. For example, whether two geometries intersect, or whether a ray is intersecting with an object. It also provides a motion model between objects using programmable physical properties of those objects as well as gravity, so that the animation appears realistic. In particular, the physics engine 122 can provide collision and interaction information between the virtual objects from the animation engine 123 and the three-dimensional representation of the real world objects in addition to interactions between virtual content.

The virtual scene database 124 is a data structure storing both the 3D and 2D virtual content to integrate in the real world. This includes the 2D content such as text or a crosshair which is provided by the UI manager 120. It also includes 3D models in a spatial database of the real world 103A (or scene) created by the SLAM engine 116 and the reconstruction engine 121, as well as the 3D models of the virtual content to display as created by the animation engine 123.

As such, the virtual scene database 124 provides the raw data to be rendered for presentation to the user's screen.

The rendering engine 118 receives the video feed from the camera 112 and adds the AR information and user interface information to the video frames for presentation to the user. The rendering engine 118's first function is to paint the video generated from the camera 112 into the screen 114. The second function is to use the pose of the device 102 (equivalent to hardware assembly 110 including the camera 112) with respect to the scene 103 and use that pose to generate the perspective view of the virtual scene database 124 from that said pose and then generate the corresponding 2D projected view 101 of this virtual content to display on the screen 114.

The rendering engine 118 renders 2D elements such as text and buttons which are fixed with respect to the screen 114 and their screen location is specified in term of screen coordinates. Those drawings are requested and controlled by the user interface manager 120 according to the state of the application. Depending on the implementation those 2D graphics are either generated every frame by application code or stored in the virtual database 124 after being created and further modified by the user interface manager 120, or a mix of both. The rendering engine 118 paints the video frames captured by the camera 112 on the screen 114 so that the user is presented with a live view of the real world in front of the device, thereby creating the effect of seeing the real world through the device 102.

The rendering engine 118 also renders in 3D the virtual content 101 to add to the scene as seen from the viewpoint of the mobile device 102 (as determined by the pose). In this embodiment, the pose is provided by the user interface manager 120, though the pose could alternatively be provided directly by the pose manager 117. To correctly occlude rendering the virtual content 101 stored in the virtual scene database 124, the rendering engine 118 first renders from the same viewpoint the virtual model of the real scene generated by the scene modeling function. In one embodiment, this virtual model of the real scene 103 is rendered transparently so it is invisible but the depth buffer is still being written with the depth of each pixel of this virtual model of the real world. This means when the virtual content 101 is added, it is correctly occluded depending on the relative depth at each pixel (i.e. at this specific pixel, is one model in front or behind the other) between the transparent virtual model of the scene overlaid on the real scene, and the virtual content. This produces the correct occlusion of the overlay 101 seen on the screen 114. The virtual model of the real scene 103 is rendered transparently, overlaid on the real scene 103. This means the video of the real scene 103 is clearly visible, creating the appearance of the real object 103 and the virtual content interacting.

The user interface (UI) manager 120 receives the pose of the device or hardware assembly 110 including camera 112 as reported by the pose manager 117, modifies or creates virtual content inside the virtual scene database 124, and controls the animation engine 123.

The overall application is controlled by the user interface manager 120, which stores the state of the application, and transitions to another state or produces application behaviors in response to user inputs, sensor inputs and other considerations. First the user interface manager 120 controls the rendering engine 118 depending on the state of the application. It might request 2D graphics to be displayed such as an introduction screen or a button or text to be displayed to show status information, such as a high-score. The user manager also controls whether the rendering engine should show a 3D scene and if so uses the pose reported by the pose manager 117 and provides it as a viewpoint pose to the rendering engine 118. In addition the user manager controls the dynamic content by taking user input from buttons or finger touch events, or using the pose of the device 102 itself, as reported by the pose manager 117. To change the virtual content inside the database 124, the user interface manager 120 uses an animation engine 123 and sends it punctual requests of the desired end state of the virtual content, for example moving some virtual content from a real location A to a real location B. The engine 123 in turn keeps updating the virtual content every frame so that the requested end state is reached after a time specified by the user interface manager.

The system 102 is further able to avoid the collision or intersection of virtual content with the real world, i.e., the virtual model of the real world 103 created by the scene modeling process, using a physics engine 122. The physics engine 122 determines if there is collision between two geometrical models. This allows for the animation engine 123 to control the animation at collision or to produce a motion path that prevents collision. By working with the interface manager 120, the animation engine 123 decides what to do with the virtual content when collision is detected. For example, when the virtual content collides with the virtual model of the real scene, the animation engine 123 could switch to a new animation showing the virtual content bouncing back into the other direction.

### Variations

The subsystem composed of the camera 112, SLAM engine 116 and reconstruction engine 121 is used to create a surface model of the real world it is currently observing. Alternate subsystems are used to provide the same functionality in other embodiments. For example, such an alternate subsystem could be composed of a flash camera or other instant depth imager (such as those integrated into system such as MICROSOFT KINECT) paired with software able to stitch the scan generated by this device into a larger surface model.

The subsystem composed of camera 112 and screen 114, implementing a “see-through” function is implemented in different ways according to various embodiments. For example that see-through device could be implemented by integrating the camera 112 and the screen 114 into an eyewear shaped device which the user can wear instead of having to hold a tablet computer or other hand-held device. In addition, some eyewear could provide the view of the real world to the user by transparency instead of by displaying the video captured by a camera.

As described, the SLAM engine 116 is further composed of two components, the mapping component which creates the visual feature map 125 and the localization component which correlates live video frames from camera 112 with the map 125 to determine the pose of the camera 112. This pose is determined with respect to the scene 103 for which the map 125 has been generated. If the geometry and texture of the observed scene is available a-priori, then it is possible to create the feature map 125 from this model without observing the scene, thereby eliminating the mapping part of the SLAM algorithm and keeping only the localization function. This would allow the localization part of the SLAM algorithm to function without first generating the map 125 by observing the scene 103 from diverse viewpoints.

### Computing Machine Architecture

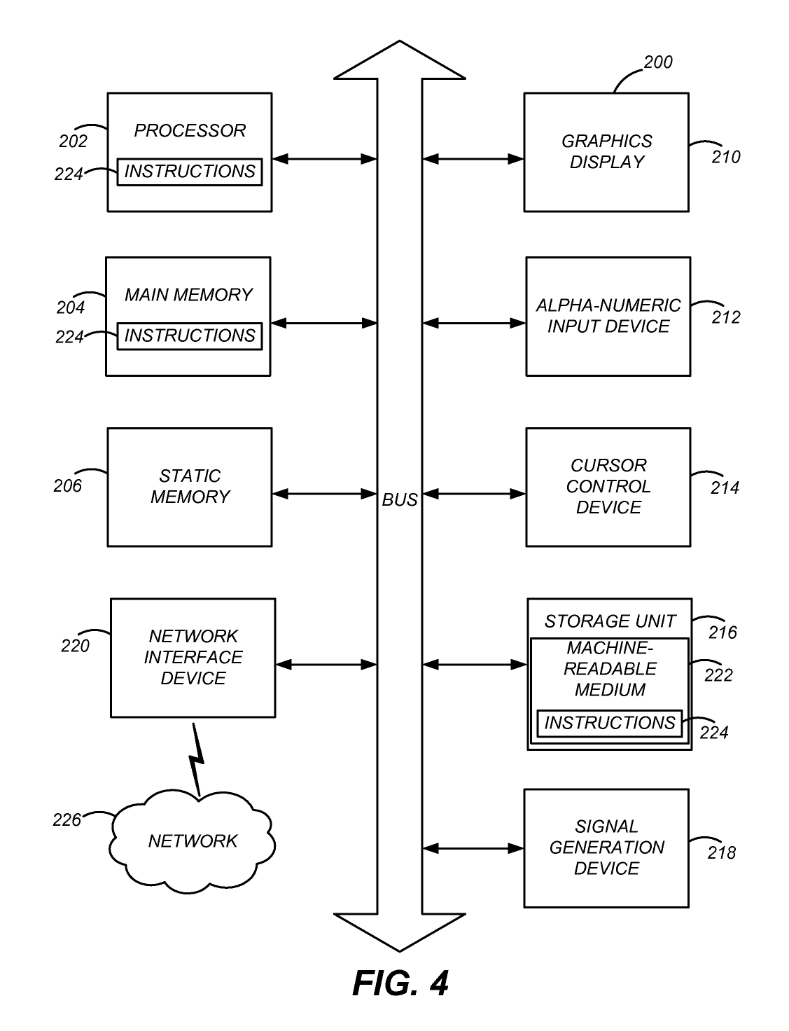

FIG. 4 is a block diagram illustrating components of an example machine able to read instructions from a machine-readable medium and execute them in a processor (or controller). Specifically, FIG. 4 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, or any machine capable of executing instructions 224 (sequential or otherwise) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes a processor 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, a static memory 206, and a camera (not shown), which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIG. 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for capturing information about real world objects, building a three-dimensional model of the real world objects, and rendering objects capable of occlusion and collusion with the three-dimensional model for rendering on a live video through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method for augmenting real-world objects with virtual content, comprising:
receiving a video feed including real-world objects;
constructing, from the video feed, a three-dimensional model including real-world objects;
determining, a position of a camera relative to the three-dimensional model;
placing a virtual object in the three-dimensional model of the real-world objects;
rendering for display, from a view of the position, unoccluded portions of the virtual object in the three-dimensional model;
overlaying the unoccluded portions of the virtual object on the video feed; and
displaying the video feed with the overlaid virtual object.

2. The computer-implemented method of claim 1, further comprising:
detecting motion of the camera; and
responsive to the detected motion of the camera, updating the camera position relative to the three-dimensional model and re-rendering the unoccluded portions of the virtual object from a view of the updated camera position.

3. The computer-implemented method of claim 2, wherein the updated rendered virtual objects remain fixed relative to the real-world objects.

4. The computer-implemented method of claim 1, further comprising:
moving the virtual object at least partially behind the real-world object from the perspective of the camera in the three-dimensional model;
re-rendering the unoccluded portions of the virtual object to exclude the portions of the virtual object that are at least partially behind the real-world object.

5. The computer-implemented method of claim 1, wherein determining the position of the camera is based on data from an inertial motion unit.

6. The computer-implemented method of claim 1, wherein determining the position of the camera is based on a simultaneous localization and mapping engine.

7. The computer-implemented method of claim 1, wherein determining the position of the camera is based on data from an inertial motion unit and a simultaneous localization and mapping engine.

8. The computer-implemented method of claim 7, wherein the position of the camera is determined by a combination of the position from the inertial motion unit and the simultaneous localization mapping engine.

9. The computer-implemented method of claim 1, wherein constructing the three-dimensional model includes identifying features from at least one frame of the video feed, wherein the features include at least one of edges, flat surfaces, and corners.

10. The computer-implemented method of claim 1, further comprising
applying a physics engine to determine collisions of the real-world objects with the virtual object.

11. A system for augmenting real-world objects with virtual content, comprising:
a processor configured to execute instructions;
a memory including instructions when executed by the processor cause the processor to:
receive a video feed including real-world objects;
construct, from the video feed, a three-dimensional model including real-world objects;
determine, a position of a camera relative to the three-dimensional model;
place a virtual object in the three-dimensional model of the real-world objects;
render for display, from a view of the position, unoccluded portions of the virtual object in the three-dimensional model;
overlay the unoccluded portions of the virtual object on the video feed; and
display the video feed with the overlaid virtual object.

12. The system of claim 11, wherein the instructions further cause the processor to:
detect motion of the camera; and
responsive to the detected motion of the camera, update the position relative to the three-dimensional model and re-render the unoccluded portions of the virtual object from a view of the updated camera position.

13. The system of claim 12, wherein the updated rendered virtual objects remain fixed relative to the real-world objects.

14. The system of claim 11, wherein the instructions further cause the processor to:
move the virtual object at least partially behind the real-world object from the perspective of the camera in the three-dimensional model;
re-render the unoccluded portions of the virtual object to exclude the portions of the virtual object that are at least partially behind the real-world object.

15. The system of claim 11, wherein determining the position of the camera is based on data from an inertial motion unit.

16. A computer-readable medium for augmenting real-world objects with virtual content, comprising instructions causing a processor to:
receive a video feed including real-world objects;
construct, from the video feed, a three-dimensional model including real-world objects;
determine, a position of a camera relative to the three-dimensional model;
place a virtual object in the three-dimensional model of the real-world objects;
render for display, from a view of the position, unoccluded portions of the virtual object in the three-dimensional model;
overlay the unoccluded portions of the virtual object on the video feed; and
display the video feed with the overlaid virtual object.

17. The computer-readable medium of claim 16, wherein the instructions further cause the processor to:
detect motion of the camera; and
responsive to the detected motion of the camera, update the position relative to the three-dimensional model and re-render the unoccluded portions of the virtual object from a view of the updated camera position.

18. The computer-readable medium of claim 17, wherein the updated rendered virtual objects remain fixed relative to the real-world objects.

19. The computer-readable medium of claim 16, wherein the instructions further cause the processor to:
move the virtual object at least partially behind the real-world object from the perspective of the camera in the three-dimensional model;
re-render the unoccluded portions of the virtual object to exclude the portions of the virtual object that are at least partially behind the real-world object.

20. The computer-readable medium of claim 16, wherein determining the position of the camera is based on data from an inertial motion unit.
